(19) United States
(12) Patent Application Publication
(10) Pub. No.: US 2026/0158599 A1
(43) Pub. Date: Jun. 11, 2026

(54) Method for Producing a Heat Exchanger and Heat Exchanger

(71) Applicant: MAHLE International GmbH, Stuttgart (DE)

(72) Inventors: Wolfgang Knödler, Waiblingen (DE); Cord Völker, Backnang (DE); Steffen Ensminger, Notzingen (DE); Matthias Gördeler, Stuttgart (DE); Lisa Buchwald, Göttingen (DE)

(21) Appl. No.: 19/409,403

(22) Filed: Dec. 4, 2025

(30) Foreign Application Priority Data
Dec. 6, 2024 (DE) 102024136561.7

(51) Int. Cl. B23P 15/26; F28F 3/12

(52) U.S. Cl. CPC B23P 15/26; F28F 3/12

(57) ABSTRACT

A heat exchanger that has at least two heat exchanger plates is provided. The heat exchanger has a core material containing an aluminum alloy. These heat exchanger plates are brazed together in a joining area such that the joint formed in the joining area is filled with filler metal between the heat exchanger plates

### CROSS-REFERENCE TO RELATED APPLICATIONS

This application claims priority from German Patent Application No. 102024136561.7, filed on Dec. 6, 2024, the entirety of which is hereby incorporated by reference herein.

The invention relates to a method for producing a heat exchanger. The invention also relates to a heat exchanger produced with this method.

Plate heat exchangers have been used for some time for cooling electric battery modules containing electric battery cells, such as those used to power electric vehicles. These heat exchangers normally contain two plates, one of which has a recess that forms a channel through which a liquid can flow when they have been brazed together. During the brazing process, these plates are thoroughly heated in order to reach the melting (liquidus) temperature for the filler metal necessary for brazing that then forms a joint between the plates when it is subsequently cooled.

A disadvantage with this for conventional heat exchangers is that it takes a relatively long time to heat the plates enough for brazing. This also requires a lot of energy.

Another aspect of the invention is to produce a heat exchanger and create a method for producing a heat exchanger in which the heat exchanger is produced in a tunnel furnace containing inert gas, without using flux for the brazing, which is fairly complex, using various combinations of materials with intermediate platings, such that a certain amount of magnesium is diffused into the joint, thus enabling flux-free brazing.

The object of the present invention is to therefore create a novel method for producing heat exchangers that resolves the above disadvantages, and to produce such a heat exchanger.

This is achieved by the subject matter of the independent Numbered Paragraphs. Preferred embodiments are the subject matter of the dependent Numbered Paragraphs.

The basic idea of the invention is to therefore create a heat exchanger that has two plates containing a ceramic material with an aluminum alloy, which are brazed together such that the area where the plates are heated during the brazing process is the area where they are joined together, or a part thereof.

Consequently, it is not necessary to heat the entire plates to the necessary brazing temperature, as they only need to reach this temperature in the area where they will be joined.

The method obtained with the invention produces a heat exchanger with preferably just two plates, specifically for cooling a battery module containing at least one battery cell. This method comprises three steps, a), b), and c). The plates that are to be joined are provided in the first step a), and contain a core material with an aluminum alloy, or are made of this core material. In the second step b), the two plates are placed together where they are to be joined. At least part of this area, preferably the entire area where they are to be joined, is then heated in the third step c) and filled with a filler metal which is then brought to slightly above the liquidus temperature to braze the two plates to one another. After the brazing, the heat exchanger is obtained and the method is completed.

No flux is needed in step c) for the brazing with this method. This substantially simplifies the brazing process, which is particularly advantageous, because relatively large contact surfaces can be brazed together therewith.

The aluminum alloy used for this contains 0.1%, to 1.1%, preferably 0.2% to 0.3% magnesium (Mg) by weight during and/or after the brazing. This ensures that the brazed heat exchanger plates are extremely sturdy.

To ensure that the aluminum alloy in the core material contains 0.1% to 1.1%, preferably 0.2% to 0.3% magnesium (Mg) by weight after the brazing, it is proposed that the core material already contains an aluminum alloy with 0.1% to 1.1%, preferably 0.2% to 0.3% magnesium (Mg) by weight in step a), thus prior to the brazing. Preferably, this core material contains an aluminum alloy according to EN 573-3/4, belonging to the group 6xxx or 3xxx, specifically 3005 or 3005mod.

There can also be two steps a0) and a1) prior to step a) in another version of the method obtained with the invention. In the first additional step a1), a wrought alloy according to EN 573-3/4 is provided as the aluminum alloy, which preferably belongs to the group 6xxx, and therefore contains more than 0.2% magnesium by weight. In the second additional step a2), this wrought alloy is plated with a material containing no more than 0.1% magnesium by weight, and preferably contains no magnesium. This plating is also an aluminum wrought alloy according to 573-3/4. This aluminum wrought alloy belongs to one of the following: group 3xxx, specifically 3003mod or 3003, group 1xxx, specifically 1145 or 1050, group 7xxx, specifically 7072, or group 6xxx, specifically 6060mod. An aluminum wrought alloy belonging to any of these groups conducts heat particularly well, and is therefore well-suited for use in the heat exchanger.

By using any of these groups, magnesium is diffused into the plating from the wrought alloy during the brazing process, specifically during the heating of the joining area necessary for the brazing in step c). Enough magnesium is diffused into the plating that the wrought alloy forming the aluminum alloy in the core material only contains a reduced magnesium content of 0.1% to 1.1%, preferably 0.2% to 0.3% magnesium by weight.

The joining area can preferably be heated in step c) in either of the above versions at a rate of more than 30° C./min to a temperature of 530° C. to 577° C.

The heat exchanger obtained by this means is extremely sturdy.

It is also proposed that a brazing plating made of an aluminum alloy be applied to at least one of the heat exchanger plates, which belongs to the group 4xxx according to EN 573-3/4, specifically 4343, 4045, or 4047. This plating can function as a protection against corrosion.

Ideally, this brazing plating contains zinc (Zn), specifically 0.5% to 6% by weight.

The invention also relates to a heat exchanger for cooling a battery module containing at least one battery cell, which has been produced with the method described above. The advantages explained above for the method obtained with the invention are therefore also obtained with the heat exchanger. This heat exchanger contains at least two, preferably exactly two, heat exchanger plates, which have a core material containing an aluminum alloy, or are made of such a core material. The aluminum alloy in the core material has 0.1% to 1.1%, preferably 0.2% to 0.3% magnesium (Mg) by weight. The heat exchanger plates are brazed together in at least one area, such that the joint therein is filled with filler metal between the plates.

In a preferred embodiment of the heat exchanger obtained with the invention, at least one of the plates has a brazing plating belonging to the group 4xxx according to EN 573-3/4, specifically 4343, 4045, or 4047. These aluminum alloys have a low melting point, which is further reduced by adding silicon, making them ideal for brazing. This plating can also function as corrosion protection.

In another embodiment, at least one plate has a brazing plating that contains zinc (Zn), specifically 0.5% to 6% by weight.

Other important features and advantages of the invention can be derived from the dependent Numbered Paragraphs, the drawings, and the descriptions of the drawings. Therein:

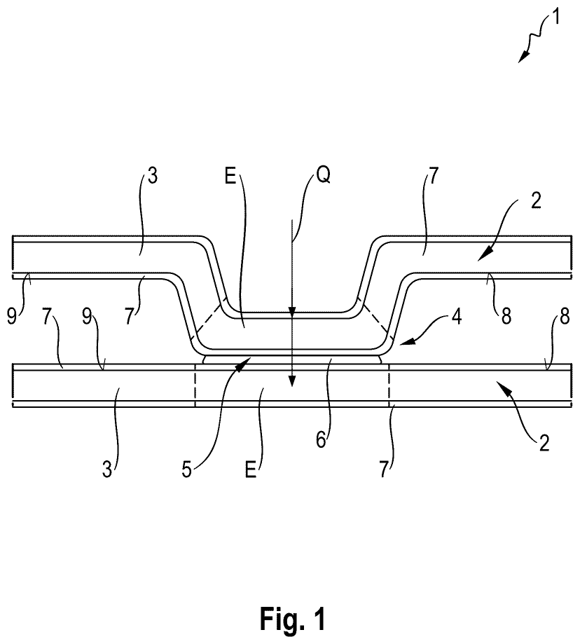

FIG. 1 shows, in a rough schematic illustration, an example of a heat exchanger 1 obtained with the invention, in a cutaway drawing, and

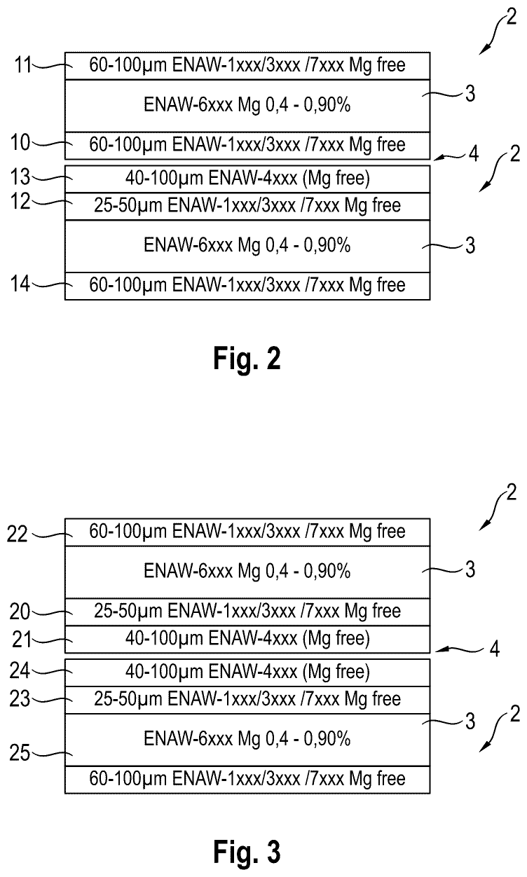

FIGS. 2 to 8 each show two heat exchanger plates made of different materials, with different core materials and layers.

It is understood that the features specified above and explained below can be used not only in the given combinations, but also in other combinations or in and of themselves, without abandoning the scope of protection for the present invention.

Preferred exemplary embodiments of the invention are shown in the drawings and shall be explained in greater detail below, in which the same reference symbols are used for identical, similar, or functionally identical components.

The heat exchanger 1 is designed to cool an electric battery module containing at least one battery cell. In the examples shown herein, the heat exchanger 1 has exactly two heat exchanger plates 2. The plates 2 each have a core material 3 containing an aluminum alloy or are made of such a core material 3. The aluminum alloy in the core material 3 contains 0.1% to 1.1%, preferably 0.2% to 0.3%, magnesium (Mg) by weight.

The heat exchanger plates 2 are brazed together in a joining area 4. The plates are brazed together in the joining area 4 such that a joint 5 between the plates 2 is filled with filler metal 6.

FIG. 1 shows that both sides 8, 9 of both plates 2 have a brazing plating 7 for corrosion protection, belonging to the 4xxx according to EN 573-3/4, specifically 4343, 4045, or 4047. This plating 7 can function as corrosion protection.

The brazing plating contains zinc (Zn), specifically 0.5% to 6% by weight.

The heat exchanger 1 is produced by a method obtained with the invention, which is described below. This method comprises three steps a), b), and c). The two plates 2 are provided in the first step a), which have a core material 3 containing an aluminum alloy, or are made of such a core material 3. In the next step b), the two plates 2 are placed together at the joining area 4, to form a joint 5 there. Heat Q is applied to at least part of the joining area 4 in the third step c), and filler metal 6 flows into the heated joining area 4 to obtain the joint 5. The brazing that takes place in step c) is obtained without a flux. The heated area E where heat Q is applied is identical to the joining area 4. The heated area E could also be just part of the joining area 4.

Once the plates 2 have been brazed together, the aluminum alloy in the core material 3 contains 0.1% to 1.1%, preferably 0.2% to 0.3%, magnesium (Mg) by weight.

A core material can be provided in step a) in which its aluminum alloy already contains 0,1% to 1.1%, preferably 0.2% to 0.3% magnesium (Mg) prior to brazing. The aluminum alloy in the core material can be an aluminum alloy according to EN 573-3/4, belonging to the group 6xxx or 3xxx, specifically 3005 or 3005mod.

Two additional steps a1) and a2) can be carried out prior to step a). A wrought alloy according to EN 573-3/4 is provided as the aluminum alloy in step a1), belonging to the group 6xxx, with a magnesium content of more than 0.2% by weight. A plating (not shown) is applied to the wrought alloy in step a2) with a magnesium content of no more than 0.1% by weight, preferably containing no magnesium at all. This plating is an aluminum wrought alloy according to 573-3/4. This aluminum wrought alloy belongs to one of the following: group 3xxx, specifically 3003mod or 3003, group 1xxx, specifically 1145 or 1050, group 7xxx, specifically 7072, or group 6xxx, specifically 6060mod.

By using any of these groups, magnesium is diffused into the plating (not shown) from the wrought alloy during the brazing process, specifically during the heating of the joining area necessary for the brazing in step c). Enough magnesium is diffused into the plating in this exemplary scenario that the wrought alloy forming the aluminum alloy in the core material only contains a reduced magnesium content of 0.1% to 1.1%, preferably 0.2% to 0.3% magnesium by weight.

A brazing plating 7 can be applied as corrosion protection to both sides of both plates 2 in the method obtained with the invention.

The brazing plating 7 can contain an aluminum wrought alloy from the group 4xxx according to EN 573-3/4, specifically 4343, 4045, or 4047. The brazing plating 7 can contain zinc (Zn), in particular 0.5% to 6% by weight.

FIGS. 2 to 8 show pairs of heat exchanger plates 2 made of different materials, with different core materials 3 and layers.

FIG. 2 shows a first plate 2 with a core material 3 made of ENAW-6xxx, with a magnesium content of 0.4% to 0.9%. The layer 10 facing the joining area 4 is made of ENAW-1xxx, -3xxx, or -7xxx, containing no magnesium, with a thickness of 60 to 100 μm. The layer 11 facing away from the joining area 4 is made of ENAW-1xxx, -3xxx, or 7xxx, containing no magnesium, with a thickness of 60 to 100 μm.

FIG. 2 shows a second plate 2 with a core material 3 made of ENAW-6xxx, with a magnesium content of 0.4 to 0.9%. The layers 12, 13 facing the joining area 4 are such that layer 12 is made of ENAW-1xxx, -3xxx, or 7xxx, containing no magnesium, with a thickness of 25 to 50 μm. The layer 13 applied thereto is made of ENAW-4xxx, containing no magnesium, with a thickness of 40 to 100 μm. The layer 14 facing away from the joining area 4 is made of ENAW-1xxx, -3xxx, or 7xxx, containing no magnesium, with a thickness of 60 to 100 μm.

FIG. 3 shows a first plate 2 with a core material 3 made of ENAW-6xxx, with a magnesium content of 0.4% to 0.9%. The layers 20, 21 facing the joining area 4 are such that layer 20 is made of ENAW-1xxx, -3xxx, or 7xxx, containing no magnesium, with a thickness of 25 to 50 μm. The layer 21 applied thereto is made of ENAW-4xxx, containing no magnesium, with a thickness of 40 to 100 μm. The layer 22 facing away from the joining area 4 is made of ENAW-1xxx, -3xxx, or 7xxx, containing no magnesium, with a thickness of 60 to 100 μm.

FIG. 3 also shows a second plate 2 with a core material 3 made of ENAW-6xxx, with a magnesium content of 0.4% to 0.9%. The layers 23, 24 facing the joining area 4 are such that layer 23 is made of ENAW-1xxx, -3xxx, or 7xxx, containing no magnesium, with a thickness of 25 to 50 μm. The layer 24 applied thereto is made of ENAW-4xxx, containing no magnesium, with a thickness of 40 to 100 μm. The layer 25 facing away from the joining area 4 is made of ENAW-1xxx, -3xxx, or 7xxx, containing no magnesium, with a thickness of 60 to 100 μm.

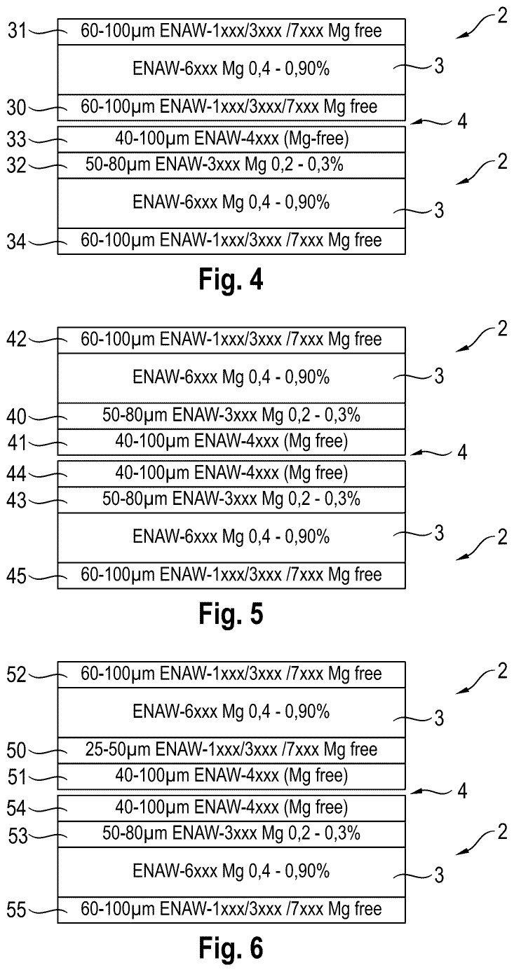

FIG. 4 shows a first plate 2 with a core material 3 made of ENAW-6xxx, with a magnesium content of 0.4% to 0.9%. The layer 30 facing the joining area 4 is made of ENAW-1xxx, -3xxx, or 7xxx, containing no magnesium, with a thickness of 60 to 100 μm. The layer 31 facing away from the joining area 4 is made of ENAW-1xxx, -3xxx, or 7xxx, containing no magnesium, with a thickness of 60 to 100 μm.

FIG. 4 shows a second plate 2 with a core material 3 made of ENAW-6xxx, with a magnesium content of 0.4% to 0.9%. The layers 32, 33 facing the joining area 4 are such that layer 32 is made of ENAW-3xxx, with a magnesium content of 0.2% to 0.3%, and a thickness of 50 to 80 μm. The layer 33 applied thereto is made of ENAW-4xxx, containing no magnesium, and has a thickness of 40 to 100 μm. The layer 34 facing away from the joining area 4 is made of ENAW-1xxx, -3xxx, or 7xxx, containing no magnesium, with a thickness of 60 to 100 μm.

FIG. 5 shows a first plate 2 with a core material 3 made of ENAW-6xxx, with a magnesium content of 0.4% to 0.9%. The layers 40, 41 facing the joining area 4 are such that layer 40 is made of ENAW-3xxx, with a magnesium content of 0.2% to 0.3%, and a thickness of 50 to 80 μm. The layer 41 applied thereto is made of ENAW-4xxx, containing no magnesium, with a thickness of 40 to 100 μm. The layer 42 facing away from the joining area 4 is made of ENAW-1xxx, -3xxx, or 7xxx, containing no magnesium, with a thickness of 60 to 100 μm.

FIG. 5 also shows a second plate 2 with a core material 3 made of ENAW-6xxx, with a magnesium content of 0.4% to 0.9%. The layers 43, 44 facing the joining area 4 are such that layer 43 is made of ENAW-3xxx, with a magnesium content of 0.2% to 0.3%, and a thickness of 50 to 80 μm. The layer 44 applied thereto is made of ENAW-4xxx, containing no magnesium, with a thickness of 40 to 100 μm. The layer 45 facing away from the joining area 4 is made of ENAW-1xxx, -3xxx, or 7xxx, containing no magnesium, with a thickness of 60 to 100 μm.

FIG. 6 shows a first plate 2 with a core material 3 made of ENAW-6xxx, with a magnesium content of 0.4% to 0.9%. The layers 50, 51 facing the joining area 4 are such that layer 50 is made of ENAW-1xxx, -3xxx, or 7xxx, containing no magnesium, with a thickness of 25 to 50 μm. The layer 51 applied thereto is made of ENAW-4xxx, containing no magnesium, with a thickness of 40 to 100 μm. The layer 52 facing away from the joining area 4 is made of ENAW-1xxx, -3xxx, or 7xxx, containing no magnesium, with a thickness of 60 to 100 μm.

FIG. 6 also shows a second plate 2 with a core material 3 made of ENAW-6xxx, with a magnesium content of 0.4% to 0.9%. The layers 53, 54 facing the joining area 4 are such that layer 53 is made of ENAW-3xxx, with a magnesium content of 0.2% to 0.3%, and a thickness of 50 to 80 μm. The layer 54 applied thereto is made of ENAW-4xxx, containing no magnesium, with a thickness of 40 to 100 μm. The layer 55 facing away from the joining area 4 is made of ENAW-1xxx, -3xxx, or 7xxx, containing no magnesium, with a thickness of 60 to 100 μm.

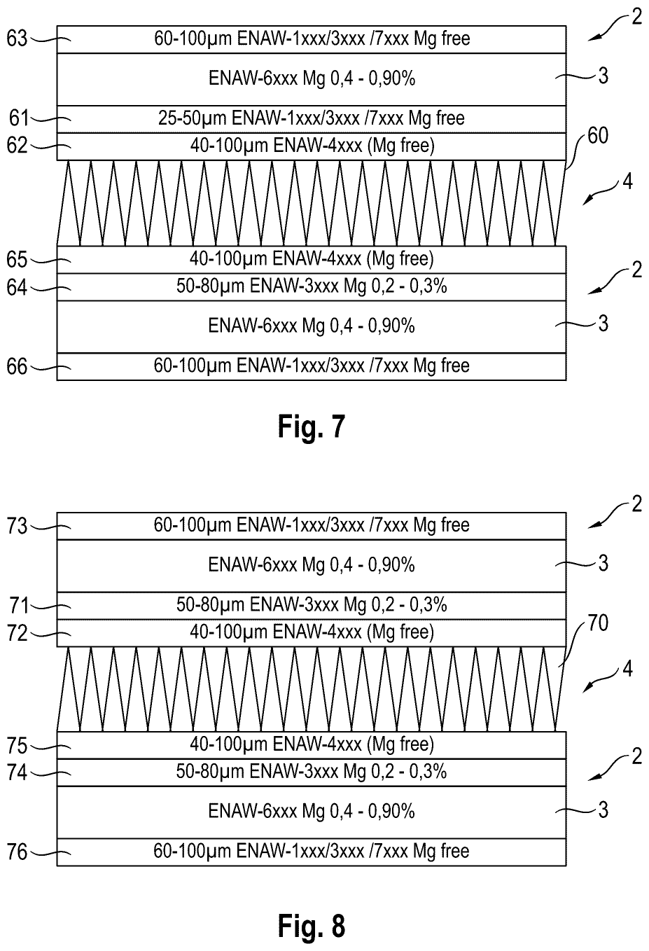

FIG. 7 shows a first plate 2 with a core material 3 made of ENAW-6xxx, with a magnesium content of 0.4% to 0.9%. The layers 61, 62 facing the joining area 4 are such that the layer 61 is made of ENAW-1xxx, -3xxx, or 7xxx, containing no magnesium, with a thickness of 25 to 50 mm. The layer 62 applied thereto is made of ENAW-4xxx, containing no magnesium, with a thickness of 40 to 100 μm. the layer 63 facing away from the joining area 4 is made of ENAW-1xxx, -3xxx, or 7xxx, containing no magnesium, with a thickness of 60 to 100 μm.

There is a corrugated web 60 between the plates 2, which is brazed thereto.

FIG. 7 also shows a second plate 2 with a core material 3 made of ENAW-6xxx, with a magnesium content of 0.4% to 0.9%. The layers 64, 65 facing the joining area 4 are such that layer 64 is made of ENAW-3xxx, with a magnesium content of 0.2% to 0.3%, and a thickness of 50 to 80 μm. The layer 65 applied thereto is made of ENAW-4xxx, containing no magnesium, with a thickness of 40 to 100 μm. The layer 66 facing away from the joining area 4 is made of ENAW-1xxx, -3xxx, or 7xxx, containing no magnesium, with a thickness of 60 to 100 μm.

FIG. 8 shows a first plate 2 with a core material 3 made of ENAW-6xxx, with a magnesium content of 0.4% to 0.9%. The layers 71, 72 facing the joining area 4 are such that the layer 71 is made of ENAW-3xxx, with a magnesium content of 0.2% to 0.3%, and a thickness of 50 to 80 μm. The layer 72 applied thereto is made of ENAW-4xxx, containing no magnesium, with a thickness of 40 to 100 μm. the layer 73 facing away from the joining area 4 is made of ENAW-1xxx, -3xxx, or 7xxx, containing no magnesium, with a thickness of 60 to 100 μm.

There is a corrugated web 70 between the plates 2, which is brazed thereto.

FIG. 8 also shows a second plate 2 with a core material 3 made of ENAW-6xxx, with a magnesium content of 0.4% to 0.9%. The layers 74, 75 facing the joining area 4 are such that layer 74 is made of ENAW-3xxx, with a magnesium content of 0.2% to 0.3%, and a thickness of 50 to 80 μm. The layer 75 applied thereto is made of ENAW-4xxx, containing no magnesium, with a thickness of 40 to 100 μm. The layer 76 facing away from the joining area 4 is made of ENAW-1xxx, -3xxx, or 7xxx, containing no magnesium, with a thickness of 60 to 100 μm.

The specification can be readily understood with reference to the following Numbered Paragraphs:
Numbered Paragraph 1. A method for producing a heat exchanger (1) with at least, preferably exactly, two heat exchanger plates (2), in particular for cooling a battery module containing at least one battery cell, wherein the method comprises:
a step a) in which at least two heat exchanger plates (2) that are to be joined together are provided, which have a core material (3) containing an aluminum alloy, or are made of such a core material,
a step b) in which the at least two heat exchanger plates (2) are placed together in at least one joining area (4), such that a joint (5) is formed between the two heat exchanger plates (2) in the at least one joining area (4),
a step c) in which heat (Q) is applied to the heat exchanger plates (2) in part of the at least one joining area (4) to braze them together, and the heat exchanger plates (2) are brazed together by filling the joint (5) with filler metal (6) in the heated joining area (4),
wherein the brazing in step c) takes place without flux, in particular in an inert gas furnace.
Numbered Paragraph 2. The method according to Numbered Paragraph 1, characterized in that the aluminum alloy in the core material (3) contains 0.1% to 1.1%, in particular 0.2% to 0.3% magnesium by weight during and/or after the brazing.
Numbered Paragraph 3. The method according to Numbered Paragraph 1 or 2, characterized in that a core material (3) is provided in step a), in which the aluminum alloy already contains 0.1% to 1.1%, preferably 0.3% to 0.9% magnesium (Mg) by weight, prior to the brazing.
Numbered Paragraph 4. The method according to Numbered Paragraph 3, characterized in that the aluminum alloy in this core material (3) is an aluminum wrought alloy according to EN 573-3/4, belonging to the group 6xxx, in particular 6060 or 6063, or 3xxx with an increased magnesium content, in particular a magnesium content greater than 0.3%.
Numbered Paragraph 5. The method according to Numbered Paragraph 4, characterized in that to provide this core material (3) in step a), the two following steps a1) and a2) are first carried out successively:
a1) providing an aluminum wrought alloy according to EN 573-3/4 that belongs to the group 6xxx and has a magnesium content of more than 0.4% by weight, as an aluminum alloy,
a2) applying a plating to the wrought alloy that contains a magnesium content of at most 0.1% by weight, preferably containing no magnesium, and also is an aluminum wrought alloy according to EN 573-3/4, and
belongs to group 3xxx, specifically 3003mod or 3003, or
belongs to group 1xxx, specifically 1145 or 1050, or
belongs to group 7xxx, specifically 7072,
such that by means of the brazing in step c), in particular during the heating of the joining area (4) necessary for the brazing, magnesium diffuses from the wrought alloy into the brazing plating (7) such that it has a magnesium content of 0.05%-0.3%, in particular 0.1% to 0.2%.
Numbered Paragraph 6. The method according to Numbered Paragraph 5, characterized in that heat is applied to the joining area (4) such that it is heated at a rate of more than 30° C./min. to a temperature of 530° C. to 577° C.
Numbered Paragraph 7. The method according to any of the preceding Numbered Paragraphs, characterized in that an aluminum wrought alloy from the group 4xxx according to EN 573-3/4 is applied to at least one heat exchanger plate (2) as a brazing plating (7), specifically 4343, 4045, or 4047.
Numbered Paragraph 8. The method according to any of the preceding Numbered Paragraphs, characterized in that the brazing plating (7) contains zinc (Zn), specifically 0.5% to 6% by weight.
Numbered Paragraph 9. A heat exchanger (1), in particular for cooling a battery module containing at least one battery cell, produced by means of the method according to any of the preceding Numbered Paragraphs,
which has at least, preferably exactly, two heat exchanger plates (2) that have a core material (3) containing an aluminum alloy, or that are made of such a core material (3),
wherein the heat exchanger plates (2) are brazed together at a joining area (4) such that a joint (5) formed in the joining area (4) is filled with filler metal (6) between the heat exchanger plates (2).
Numbered Paragraph 10. The heat exchanger (1) according to Numbered Paragraph 9, characterized in that the aluminum alloy in the core material (3) contains 0.1% to 1.1%, in particular 0.3% to 0.9% magnesium (Mg) by weight.
Numbered Paragraph 11. The heat exchanger (1) according to Numbered Paragraph 9 or 10, characterized in that at least one heat exchanger plate (2) has a brazing plating (7) belonging to the group 4xxx according to EN 573-3/4, specifically 4343, 4045, or 4047.
Numbered Paragraph 12. The heat exchanger (1) according to Numbered Paragraph 9, 10, or 11, characterized in that at least one heat exchanger plate (2) has a brazing plating (7) that contains zinc (Zn), in particular 0.5% to 6% by weight.

### LIST OF REFERENCE SYMBOLS

1 heat exchanger
2 heat exchanger plate
3 core material
4 joining area
5 joint
6 filler metal
7 brazing plating
8 side facing the joint
9 side facing away from the joint
10 layer facing the joint
11 layer facing away from the joint
12 layer facing the joint
13 layer facing the joint
14 layer facing away from the joint
20 layer facing the joint
21 layer facing the joint
22 layer facing away from the joint
23 layer facing the joint
24 layer facing the joint
25 layer facing away from the joint
30 layer facing the joint
31 layer facing away from the joint
32 layer facing the joint
33 layer facing the joint
34 layer facing away from the joint
40 layer facing the joint
41 layer facing the joint
42 layer facing away from the joint
43 layer facing the joint
44 layer facing the joint
45 layer facing away from the joint
50 layer facing the joint
51 layer facing the joint
52 layer facing away from the joint
53 layer facing the joint
54 layer facing the joint
55 layer facing away from the joint
60 corrugated web
61 layer facing the joint
62 layer facing the joint
63 layer facing away from the joint
64 layer facing the joint
65 layer facing the joint
66 layer facing away from the joint
70 corrugated web
71 layer facing the joint
72 layer facing the joint
73 layer facing away from the joint
74 layer facing the joint
75 layer facing the joint
76 layer facing away from the joint

1-12. (canceled)

13. A method for producing a heat exchanger with at least two heat exchanger plates that are configured for cooling a battery module containing at least one battery cell, wherein the method comprises:
a step a) providing the at least two heat exchanger plates that are to be joined together, wherein the heat exchanger plates either comprise a core material containing an aluminum alloy, or are made of such a core material,
a step b) placing together the at least two heat exchanger plates in at least one joining area, such that a joint is formed between the two heat exchanger plates in the at least one joining area,
a step c) applying heat to the heat exchanger plates to at least a portion of the at least one joining area to braze the heat exchanger plates together, wherein the heat exchanger plates are brazed together by filling the joint with filler metal in the heated joining area,
wherein the brazing in step c) takes place without flux.

14. The method according to claim 13, wherein the aluminum alloy in the core material contains 0.1% to 1.1% magnesium by weight during and/or after the brazing.

15. The method according to claim 13, further comprising the step of providing a core material in step a), in which the aluminum alloy already contains 0.1% to 1.1%, preferably 0.3% to 0.9% magnesium (Mg) by weight prior to the brazing.

16. The method according to claim 15, wherein the aluminum alloy in the core material is an aluminum wrought alloy according to EN 573-3/4, belonging to the group 6xxx, or 3xxx with an increased magnesium content greater than 0.3%.

17. The method according to claim 16, wherein the core material provided in step a), is prepared by the two following steps a1) and a2) are first carried out successively:
a1) providing an aluminum wrought alloy according to EN 573-3/4 that belongs to the group 6xxx and has a magnesium content of more than 0.4% by weight, as an aluminum alloy,
a2) applying a plating to the wrought alloy that contains a magnesium content of at most 0.1% by weight, and also is an aluminum wrought alloy according to EN 573-3/4, and
belongs to group 3xxx, or
belongs to group 1xxx, or
belongs to group 7xxx,
such that by means of the brazing in step c), during the heating of the joining area necessary for the brazing, magnesium diffuses from the wrought alloy into the brazing plating such that it has a magnesium content of 0.05%-0.3%.

18. The method according to claim 17, wherein heat is applied to the joining area such that it is heated at a rate of more than 30° C./min. to a temperature of 530° C. to 577° C.

19. The method according to claim 13, wherein an aluminum wrought alloy from the group 4xxx according to EN 573-3/4 is applied to at least one heat exchanger plate as a brazing plating.

20. The method according to claim 13, wherein the brazing plating contains 0.5% to 6% by weight zinc (Zn).

21. A heat exchanger, in particular for cooling a battery module containing at least one battery cell, produced by means of the method according to claim 13, comprising:
at least two heat exchanger plates that have a core material containing an aluminum alloy, or that are made of such a core material,
wherein the heat exchanger plates are brazed together at a joining area such that a joint formed in the joining area is filled with filler metal between the heat exchanger plates.

22. The heat exchanger according to claim 21, wherein the aluminum alloy in the core material contains 0.1% to 1.1% magnesium (Mg) by weight.

23. The heat exchanger according to claim 21, wherein at least one heat exchanger plate of the at least two heat exchanger plates has a brazing plating belonging to the group 4xxx according to EN 573-3/4.

24. The heat exchanger according to claim 21, wherein at least one heat exchanger plate has a brazing plating that contains 0.5% to 6% by weight zinc (Zn).

25. The method of claim 13, wherein the heat exchanger comprises exactly two heat exchanger plates.

26. The method of claim 13, wherein, the brazing step is performed in an inert gas furnace.

27. The method of claim 14, wherein the aluminum alloy in the core material contains 0 0.2% to 0.3% magnesium by weight during and/or after the brazing.

28. The method of claim 15, wherein the aluminum alloy already contains 0.3% to 0.9% magnesium (Mg) by weight prior to the brazing.

29. The method of claim 16, wherein the aluminum alloy in the core material is the aluminum wrought alloy according to EN 573-3/4, belonging to the group 6060 or 6063.

30. The method of claim 30, wherein the plating applied to the wrought alloy belongs to group 3003mod or 3003.

31. The method of claim 30, wherein the plating applied to the wrought alloy belongs to group 1145 or 1050.

32. The method of claim 30, wherein the plating applied to the wrought alloy belongs to group 7072.
